(19) United States
(12) Patent Application Publication
(10) Pub. No.: US 2005/0143533 A1
(43) Pub. Date: Jun. 30, 2005

(54) Thermosetting moulding composition

(76) Inventors: Florent Raviola, Vaureal (FR); Lorenzo Poggi, Milan (IT); Lionel Landru, Lauwette (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/493,133

(22) PCT Filed: Oct. 22, 2002
(86) PCT No.: PCT/FR02/03614

(30) Foreign Application Priority Data
Oct. 24, 2001 (FR) 01/13874

(51) Int. Cl. C08L 63/00; C08L 67/00

(52) U.S. Cl. 525/445; 525/529

(57) ABSTRACT

The invention concerns a thermosetting moulding composition comprising: a polyester or vinyl ester epoxy resin (A) in solution in an ethylenically unsaturated liquid monomer (B); at least an anti-shrink additive (C); an organic peroxide catalyst; and a mineral filler. Said composition is characterized in that the ethylenically unsaturated liquid monomer (B) is a vinyltoluene and/or a t-butyl styrene; and the anti-shrink additive(s) is/are free of add functionality and is/are selected among methyl methacrylate copolymers and a comonomer which is a vinyl and/or a methyl acrylate and/or ethyl acrylate monomer, in solution in the ethylenically unsaturated monomer (B). Such a composition is designed, in particular, for the automotive industry.

The present invention relates to a moldable thermo-setting composition, in particular based on unsaturated polyester resin, intended especially for the automotive industry.

Conventional unsaturated polyester resins usually comprise an unsaturated polyester diluted in a monomer comprising ethylenic unsaturation (vinyl or acrylic unsaturation) in order to adjust the viscosity according to the application. This monomer acts as a solvent for the polyester and for the crosslinking agent. During the crosslinking (or curing) of the polyester and of the monomer, volume shrink is observed. This shrink leads to cracks, appearance defects and the warping of the components. Shrink-compensating agents, which are generally thermoplastic substances, are therefore added. Introduced in the powder form or diluted in styrene, these agents are of polystyrene, polyethylene, poly(vinyl chloride) or poly(methyl methacrylate) nature, resulting in linear shrinks, after molding, of 0.2% to 0.1% (low shrink), or else of poly(vinyl acetate), saturated polyester or elastomeric nature, resulting in shrinks of close to zero (low profile). Whether or not these shrink-compensating additives are soluble in the resins before crosslinking, they result in a phase separation during crosslinking. The microdomains formed generate a volume of space, compensating for the shrink of the polyester.

Moldable thermosetting compositions are applied in particular in fields where it is desired to obtain molded components with a perfectly smooth surface which can be coated, for example, with a layer of paint, of varnish or of a metal substance; this is the case in particular with components for automobiles, for example components for the automobile body and reflectors for lighting devices.

Body components for automobiles are manufactured by molding, for example by compression or injection, thermosetting materials of the BMC (Bulk Molding Compound) type or of the SMC (Sheet Molding Compound) type mainly comprising an unsaturated polyester resin, inorganic fillers and reinforcing fibers and at least one shrink-compensating agent, in particular poly(vinyl acetate). This agent is particularly important for BMCs or SMCs intended to form automobile body components as it is necessary to obtain, in some cases, a zero or virtually zero shrink (low profile) and, in other cases, a slight expansion to meet Class A the requirements of of the automobile sector (for example, production of a perfectly smooth surface free from cavities or holes).

Thus, Japanese patent application No. JP900407332 relates to a composition comprising an unsaturated polyester resin, a thermoplastic resin, such as polystyrene, and fine particles of poly(methyl methacrylate) in a proportion of 0.005 to 5% with respect to the unsaturated polyester resin.

French patent application No. 2 021 415 provides a resin system comprising an unsaturated polyester, a monomer comprising ethylenic unsaturation and a thermoplastic polymer having an acid functionality.

European patent application No. 454 517 has as subject matter a moldable composition comprising an unsaturated polyester resin in styrene, fillers, glass fibers, an antishrink agent, which is poly(methyl methacrylate) in styrene, and a mold-release agent, which is a calcium salt of montanic acid.

Japanese patent application No. JP63069812 provides a molding material obtained by blending an unsaturated polyester resin of hydrogenated bisphenol type, styrene, a crosslinking initiator, which is t-butylperoxy isopropyl carbonate, an antishrink agent, such as poly(methyl methacrylate), a filler, a reinforcing agent, a mold-release agent and a colorant.

Japanese patent application No. JP06025539 relates to colored particles of resin which are obtained by dissolution of a thermoplastic resin in an unsaturated polyester resin, addition of a filler, of a pigment, of a curing accelerator and of a radical curing agent, curing of the blend and milling to produce the particles.

Japanese patent application No. JP61057644 relates to a composition comprising:
(A) an unsaturated polyester resin having a molecular mass of 400 or less per double bond, which is obtained by reaction of a diacid compound, which is an unsaturated diacid or consists of an unsaturated diacid and a saturated diacid, with a glycol derivative;
(B) poly(methyl methacrylate) or a copolymer based on methyl methacrylate having a weight-average molar mass of 50 000 to 500 000 and a size of at most 1 mm,
(C) an inorganic filler comprising at least 70% by weight of aluminum hydroxide, and
(D) an unsaturated ethylenic monomer;
   in which the ratio by mass of the compound (A) to the compound (B) is from 70/30 to 90/10, the ratio by mass of the sum of compounds (A) and (B) to compound
(C) is from 10/90 to 35/65 and the amounts of compound
(D) in the composition is at most 5%.

It is also known to prepare moldable thermosetting compositions, in particular based on unsaturated polyester resin, in order to obtain molded articles with a virtually zero final shrink (generally referred to as low profile—within 0 and 0.05% approximately) or a slight expansion, that is to say a dimensional increase of +0.02% to +0.09%, for example.

This is the case with European patent application No. 751 184, which relates to moldable and pigmentable thermosetting compositions of use in the production of molded articles with zero shrink or slight expansion, comprising, by weight,
from 15 to 45% of thermosetting resin, diluted in a monomer comprising ethylenic unsaturation,
from 0.1 to 1% of catalyst,
from 3 to 15% of (meth)acrylic polymer powder with a size of less than 150 μm,
from 3 to 60% of inorganic fillers,
from 0 to 5% of organic or inorganic pigments,
up to 60% of reinforcing fibers.

The Applicant Company has found that the disadvantages of the known moldable thermosetting compositions are mainly related to the fact that the materials formed from these compositions are subject to losses in mass when exposed to high temperatures. Such losses in mass originate in particular from the release of volatile materials which occurs when these materials are subjected to high temperatures.

The emission of volatile materials is a nuisance, first, because it results in the appearance of bubbles in the surface coating (paint, varnish) applied subsequently and, secondly, because, during subsequent use at high temperature, the quality of the coating is reduced.

None of the solutions of the documents of the prior art satisfactorily solves the problem posed by the production of a composition which, first, results in molded articles with a virtually zero final shrink and secondly, avoids the emission of volatile materials during subsequent heat treatments.

The subject matter of the invention is thus a moldable thermosetting composition which introduces a satisfactory solution to the problem which has just been mentioned.

This composition comprises:
an unsaturated polyester resin or vinyl ester epoxy resin (A) in solution in a liquid monomer comprising ethylenic unsaturation (B);
at least one antishrink additive (C);
an organic peroxide catalyst intended to initiate the crosslinking of the resin (A),
an inorganic filler, in particular of the calcium carbonate type;
   and it is characterized in that:
   the liquid monomer comprising ethylenic unsaturation (B) is vinyltoluene and/or a t-butylstyrene; and
   the antishrink additive(s) (C) is/are devoid of acid functionality and is/are chosen from copolymers of methyl methacrylate and of a comonomer which is a vinyl monomer and/or methyl acrylate and/or ethyl acrylate, in solution in the monomer comprising ethylenic unsaturation (B).

Such a composition therefore has the advantage of being able to be homogeneous or overall homogeneous, in the sense that its constituents (including the fillers, such as glass fibers or beads) can be distributed homogeneously.

The composition according to the invention has applications in the field of the automotive industry. It makes it possible in particular to prepare certain automobile fittings, such as, for example, headlight parabolic reflectors, cylinder-head covers or induction pipes.

However, this composition also has applications in other technical fields in which the temperature behavior assumes a degree of importance. Mention may in particular be made, in this respect, of the field of electricity, for example for producing switches, the field of domestic electrical appliances, for example for manufacturing microwave ovens or coffee-makers, and the field of construction, for producing painted components.

According to a preferred embodiment of the invention, the composition according to the invention additionally comprises a specific wetting agent which exhibits the advantage of not exuding at the surface of the molded articles.

A second subject matter of the present invention is a process for the preparation of the moldable thermosetting composition according to the invention.

A third subject matter of the present invention is a rigid item obtained by crosslinking a composition according to the invention. Such an item can therefore be homogeneous.

A fourth subject matter of the present invention is a solution of copolymer -of methyl methacrylate and of styrene in vinyltoluene and/or t-butylstyrene.

A fifth subject-matter of the present invention is a thermosetting composition comprising a solution of copolymer of methyl methacrylate and of styrene in vinyltoluene and/or t-butylstyrene.

A fifth subject-matter of the present invention is the use of such a solution in a thermosetting composition.

Other characteristics and advantages of the invention will now be described in detail in the account which follows.

### DETAILED ACCOUNT OF THE INVENTION

In the thermosetting composition according to the invention, the resin (A) can be vinyl ester epoxy or an unsaturated polyester. The latter is, as is well known, a polyester resulting from the polycondensation of at least one unsaturated diacid or its anhydride and of at least one diol. Mention may in particular be made of maleic acid and its anhydride and fumaric acid. Small amounts of saturated aliphatic, cycloaliphatic or aromatic diacids or anhydrides can be employed to modify the mechanical and chemical properties of the final product. Thus, use may be made of orthophthalic acid and its anhydride, isophthalic acid, adipic acid or tetrahydrophthalic anhydride. For resins with improved flame retardancy, use may be made of halogenated monomers, such as tetrabromo- or tetrachlorophthalic anhydride and hexachloroendomethylenetetrahydrophthalic acid. The main diols generally used are ethylene glycol, propylene glycol, diethylene glycol, dipropylene glycol, neopentyl glycol or 1,3-butanediol.

The thermosetting resin can also be a vinyl ester epoxy resin, which is an epoxy resin modified by an acid, in particular a (meth)acrylic acid.

The monomer comprising ethylenic unsaturation (B) is used in particular to dilute the thermosetting resin, in order to obtain the resin with the viscosity necessary for the application. It is also used to form the three-dimensional network during the crosslinking.

According to the present invention, it is also used to dilute the antishrink additive (C).

The monomer comprising ethylenic unsaturation (B) is vinyltoluene or t-butylstyrene. Preferably, the monomer (B) is vinyltoluene.

According to a preferred embodiment of the invention, the polyester resin or the vinyl ester epoxy resin (A) is diluted in the monomer (B) in a proportion of 10 to 70% and preferably of 20 to 65% by weight.

Thus, the components obtained by crosslinking the composition according to the invention are much more stable at 200 and 220° C.

The composition according to the invention comprises at least one antishrink additive (C) chosen from copolymers of methyl methacrylate and of a comonomer which is a vinyl monomer and/or methyl acrylate and/or ethyl acrylate.

The antishrink additive (C) is preferably used in the form of a solution in the monomer (B) in the proportion of 10 to 55% by weight, in particular of 20 to 45%.

In addition to its antishrink effect, this copolymer (C) also helps in the homogenization and in the stabilization of the combined constituents of the thermosetting composition as a result of the increase in the viscosity probably related to the absorption of the monomer comprising ethylenic unsaturation.

Mention may be made, as vinyl monomer which can be used to prepare the copolymer (C), of styrene, α-methylstyrene or vinyltoluene.

Preferably, the copolymer (C) is a copolymer of methyl methacrylate and of styrene.

Use is made in particular of a copolymer (C) of methyl methacrylate and of styrene comprising from 20 to 60% and preferably from 40 to 50% by weight of styrene.

The weight-average molar mass of compound (C) is generally between 50 000 and 500 000 g/mol.

The composition according to the invention also comprises at least one inorganic filler which can be calcium carbonate, aluminum hydroxide, and the like. As is well known, the filler introduces properties such as Theological properties, better flame retardancy or chemical properties.

The total amount of inorganic filler represents from 10 to 70% of the weight of the thermosetting composition.

Preferably, calcium carbonate is used as filler.

According to a preferred embodiment of the invention, the thermosetting composition furthermore comprises a wetting agent. This is because it is advantageous to resort to a wetting agent insofar as the latter is not substantially subject to phenomena of exudation towards the surface of the molded component, once the latter has been produced.

A liquid wetting agent, which is known as such, is an organic combination, composed of polar and nonpolar groups, which makes it possible -to reduce the interfacial tension in reinforced and filler-comprising unsaturated polyesters. Such a wetting agent is, for example, the product sold under the trade name Byk-W9050 by Byk.

The wetting agent advantageously represents from 0.5 to 1.5% of the total weight of the thermosetting composition.

In the moldable thermosetting composition according to the invention, this wetting agent substitutes for mold-release agents of the prior art, such as calcium stearate and zinc stearate, which give rise to the abovementioned exudation phenomenon.

Thus, in the prior art in which these two mold-release agents are resorted to, when the molded components are, for example, degreased and then rinsed, these various treatments are not satisfactorily effective because of this exudation phenomenon. This thus results in the high level of discarding of the components, which the invention makes it possible to substantially reduce.

The thermosetting composition according to the invention additionally comprises from 0.1% to 1% of a catalyst in order to bring about the crosslinking of the thermosetting resin. Use is generally made, as catalyst, of an organic peroxide which can be, depending on the polymerization temperature, di(tert-butyl) peroxide, tert-butyl peroctoate (TBPEH), tert-butyl perbenzoate and benzoyl peroxide.

The thermosetting composition according to the invention can also comprise various additives. Mention may be made, for example, of a maturing agent, such as an alkaline earth metal oxide or hydroxide, in particular magnesium oxide (magnesia).

Mention may also be made of reinforcing fibers, generally up to 60% of the total weight of the composition. These reinforcing fibers are generally chosen from glass fibers with a length of between 3 and 25 mm, carbon fibers or aramid fibers, such as those sold under the trade name by Dupont de Nemours.

The thermosetting composition according to the invention can also comprise plant and/or synthetic fibers, for example up to 45% by weight of the composition and in particular from 5 to 35%. Use may be thus be made of cellulose fibers, as disclosed in French patent application No. 2 704 863, which makes it possible to reduce the density of the composition so that the components molded from this composition are much lighter. The fibers can be of various origins, optionally formed from milled recycled components, for example cellulose fibers, such as wood fibers, cotton fibers, and the like, or synthetic fibers (polypropylene, poly(ethylene terephthalate), and the like), and of different lengths (a few microns to a few millimeters).

The thermosetting composition according to the invention can also comprise inhibitors, added in a proportion of at most 0.1%, in order to prevent the crosslinking of the polyester during synthesis or during dilution with the monomer comprising ethylenic unsaturation (B). Mention may be made, as inhibitor, of hydroquinone, benzoquinone and para-benzoquinone. It can also comprise any compound which allows it to be stored before use, for example a mixture of Ionol and of styrene.

The thermosetting composition according to the invention can comprise up to 10% by weight, and preferably from 5 to 10% by weight, of glass microspheres, for the purpose of improving the optical reflection, for example for producing reflectors for lighting devices.

The thermosetting composition according to the invention can also comprise organic or inorganic pigments or dyes, such as animal black, iron oxide, and the like. These pigments or dyes can therefore be homogeneously distributed, which results in molded components which are perfectly pigmented throughout the body of the component. These components can thus be used for any article which has to exhibit a homogeneous color throughout its body, for example domestic electrical appliances, automobile components, and the like.

Because of the homogeneous distribution of the pigments in the composition according to the invention, it is possible to obtain, if these pigments are conductive, components having a surface resistivity of between 10³ and 10⁷ Ω/log₁₀ (measured according to Standard NFC 26215). With such a surface condition, the components can be covered with a paint using an electrostatic spray gun without requiring the deposition of a conductive priming coat. To form paraboloid reflectors (reflectors) for automobile headlights, for example, the deposition of an aluminum layer (aluminizing) can be carried out directly on the molded component without the conventional preliminary treatment being necessary.

The compositions for forming molded components having a surface resistivity of between 10³ and 10⁷ Ω/log₁₀ comprise from 1 to 4% of conductive substances, in particular carbon black.

A preferred composition of the invention comprises:
(A) from 8 to 30% of unsaturated polyester of the maleic type, added in the form of solution in vinyltoluene (B),
(C) from 4 to 15% of a copolymer of methyl methacrylate and of styrene, added in the form of a solution in vinyltoluene (B),
(D) from 30 to 70% of calcium carbonate,
(E) from 0.2 to 1% of an organic peroxide,
(F) from 5 to 50% of reinforcing fibers, and
(G) from 0.6 to 1.2% of wetting agent.

The inventors have also found, with surprise, that a synergistic effect occurs when the copolymer (C) of methyl methacrylate and-of styrene, as described above, is used in solution in vinyltoluene.

Such a combination behaves as an excellent scavenger or trapper of volatile materials. Curiously, this effect is not encountered when the copolymer (C) is in solution in styrene.

Such an effect thus constitutes a decisive advantage in reducing the emissions of volatile materials during molding operations at 150° C. and varnishing operations, painting operations, and the like, at high temperature (220° C.).

Preparation

The thermosetting composition according to the invention can be prepared by employing conventional equipment, such as a Z-arm mixer, a Drais mixer (centrally-rotating plowshare mixer), a TMC or AMC (machines of the 2-roll calender type), an SMC (Sheet Molding Compound).

Generally, the process for the preparation of a thermo-setting composition according to the invention comprises:
if appropriate, a stage of producing a first blend of the inorganic filler with optional additives,
a stage of producing a second blend of the constituents (A), (B) and (C) and of the other optional liquid or soluble constituents,
a stage of introducing the inorganic filler or, if appropriate, the first blend into the second blend.

The copolymer (C) can be employed in the form of beads which are dissolved in the monomer (B). These beads can be obtained by aqueous suspension and polymerization, for example according to the process disclosed in

European patent application No. 457 356 or that disclosed in European patent application No. 683 182.

The beads of copolymer (C) generally have a size of between 30 and 400 microns and preferably between 60 and 200 microns.

The composition according to the invention can subsequently be obtained by various processes.

The preferred process consists in using two mixers.

A first ribbon blender makes it possible to prepare a homogeneous blend of the solid components, for example of the various inorganic fillers, of the glass fibers and of the optional cellulose fibers.

A second Z-arm mixer is used in a first step for the blending of the liquid components (resins, catalysts, dyes, and the like) and of the powder formed of the copolymer (C) in solution in the monomer (B). It is subsequently used for the final operation, which consists of impregnating the blend of the solid components using the liquid blend.

By way of example, the first ribbon blender has a capacity of 1200 liters and is charged with 300 kg of solid materials. These materials are blended therein for one and a half minutes at 42 revolutions/min.

The second Z-arm mixer also has a capacity of 1200 liters and operates at 27 revolutions/min. The blending of the liquid components lasts approximately 10 min and impregnation of the solid components lasts from 4 to 6 min, depending on the percentage of glass fibers.

Uses

The thermosetting composition according to the invention can be used in all kinds of applications related to resistance to heat, in the fields of electricity, for switches, of domestic electrical appliances, for microwave ovens, coffee-makers, toasters, and the like, of construction, for internal and external painted components, and the like.

The components obtained by crosslinking the composition according to the invention exhibit a “low profile” shrink (shrink of 0 to 0.05% approximately) or a slight expansion (of the order of +0.05% to +0.09%), which makes it possible to use them in particular for automobile body components.

The molded components obtained from the composition according to the invention exhibit a very smooth surface which is devoid of defects, in particular of cavities or holes, at the location of reinforcing ribs and bosses.

In addition, these components are particularly advantageous because they do not produce excessively great emissions at high temperature (220° C.) during varnishing operations, painting operations, aluminizing operations, galvanizing operations, and the like.

The composition is therefore advantageously used as moldable thermosetting composition of the BMC (Bulk Molding Compound), DMC (mastic paste) or SMC (Sheet Molding Compound) type.

In addition, the molded components obtained from the composition according to the invention can continuously withstand, for several thousand hours, a temperature of 150° C. or more.

These components therefore have applications as headlight parabolic reflectors, automobile body components, components under the engine hood, and the like.

### EXAMPLES

The following examples illustrate the present invention without, however, limiting the scope thereof.

### Example 1

The composition according to the invention is prepared which has the following formulation:
10.3% of a 60% by weight solution of unsaturated polyester resin of maleic type in vinyltoluene;
10.2% of a 40% by weight solution of powder formed of copolymer (*) in vinyltoluene;
0.20% of catalyst, which is TBPEH (organic peroxide);
0.0010% of para-benzoquinone (inhibitor);
0.016% of mixture of Ionol and of styrene, in equal proportions by weight (preservative);
0.60% of the liquid wetting agent Byk-W9050;
66.68% of calcium carbonate;
12.00% of 6 mm glass fibers, of E type.

(*): The copolymer was composed of 60% by weight of methyl methacrylate and of 40% by weight of styrene; its weight-average molar mass was from 100 000 to 150 000 g/mol.

### Example 2 (Control)

A composition according to the prior art of the BMC type is prepared by replacing, in the composition of example 1, the methacrylic copolymer (C) by a conventional antishrink agent, namely poly(vinyl acetate), and vinyltoluene by styrene.

### Example 3

A sample of 4 g of each of the compositions of examples 1 and 2 is crosslinked and then the crosslinked samples are tested by maintaining them at 200-220° C. for 80 000 minutes.

The volatile materials released are analyzed by gas chromatography and mass spectrometry.

The following products are identified for the crosslinked composition of the prior art:
3-methylheptane: 12.8%
1-octene: 13.7%
ethylbenzene: 16.7%
dimethylbenzene: 17.1%
styrene: 19%
benzaldehyde: 20.7%

When tested at 220° C. for 80 000 minutes (55 days), the crosslinked composition of the prior art loses 20% of its mass and there is a great decline in its physical and mechanical characteristics.

The crosslinked composition according to the invention is also maintained at a temperature of 220° C. for 80 000 minutes.

The losses in weight at 200° C. and 220° C. observed over 80 000 minutes (55 days) on plaques of 100×100×4 mm according to the invention (example 1) or according to the prior art (example 2) can be compared in the following table.

| | | Composition |
|---|---|---|
| | | according to |
| | BMC of the prior art | the invention |
| Time in | (Ex. 2) | (Ex. 1) |

| minutes | 200° C. | 220° C. | 200° C. | 220° C. |
|---|---|---|---|---|
| 5000 | 2% | 3% | 0.60% | 1.40% |
| 10 000 | 2.80% | 7% | 0.90% | 2% |
| 15 000 | 3.40% | 11% | 1.40% | 2.50% |
| 20 000 | 5.40% | 13% | 1.45% | 2.60% |
| 25 000 | 6.40% | 14% | 1.60% | 2.80% |
| 30 000 | 7.60% | 15% | 1.65% | 2.90% |
| 40 000 | 9.10% | 16.10% | 1.80% | 3% |
| 50 000 | 11.90% | 18% | 2% | 3.50% |
| 60 000 | 12.80% | 19% | 2.35% | 3.75% |
| 70 000 | 12.90% | 19.6% | 2.70% | 3.85% |
| 80 000 | 13.20% | 20% | 2.90% | 4% |

(The materials are assessed as stabilized from 80 000 minutes. The differences in weight are due to the uptake of moisture, a normal phenomenon with regard to materials of this type during the cooling of the plaques.)

It is found that the loss in mass of the composition according to the invention is only 4%, which is approximately one fifth the loss in mass of the crosslinked composition of the prior art.

In addition, a good part of the mechanical and physical properties of the composition according to the invention has been retained.

Thus, it turns out that the use of the copolymer (C), combined with the use of a vinyltoluene and/or of a t-butylstyrene, makes it possible to eliminate, to a substantial extent, the phenomena of release of volatile materials mentioned above. This is because, under these conditions, the copolymer (C) behaves as a scavenger of volatile materials.

Consequently, the use of this composition for producing components which have to continuously withstand temperatures of 180° C. can be fully envisaged.

In particular, this improved resistance to high temperatures is particularly advantageous for numerous components intended for the automotive industry:
structural or body components subjected to high temperatures (approximately 220° C.) during painting operations (cataphoresis);
components under the engine hood, such as cylinder-head covers and oil sumps.

### Example 4

Compositions were prepared as in example 1 using, in place of the copolymer (C), different copolymers C1 and C2, the compositions which, expressed as % by mass, were as follows:
C1: 88% of methyl methacrylate and 12% of ethyl acrylate (weight-average molar mass: 70 000 to 80 000 g/mol)
C2: 50% of a copolymer composed of 98% of methyl methacrylate and 2% of methyl acrylate (weight-average molar mass: 90 000 to 100 000 g/mol) and 50% of a copolymer composed of 96% of methyl methacrylate and 4% of ethyl acrylate (weight-average molar mass: 100 000 to 120 000 g/mol).

The losses in weight, at 220° C. over 24 000 minutes, were then measured, as indicated in example 3, on plaques obtained from the compositions comprising the copolymers C1 and C2.

These losses in weight were evaluated respectively as 6% and 6.5%.

### Example 5 (Control)

The preparation was carried out as indicated in example 1 but while replacing the copolymer of methyl methacrylate (60%) and of styrene (40%) by a copolymer of methyl methacrylate (98%) and of methyl acrylate (2%) in solution in styrene instead of vinyltoluene, and 12.65% of a 40% solution of this copolymer in styrene were used.

The losses in weight were measured as indicated in example 3.

The results are as follows:

| | BMC of the prior art |
|---|---|
| Time in minutes | 200° C. |
| 5000 | 1.3% |
| 10 000 | 2.2% |
| 15 000 | 3.5% |
| 20 000 | 6.6% |
| 25 000 | 8.6% |
| 30 000 | 9.1% |
| 40 000 | 11.6% |
| 50 000 | 12.4% |
| 60 000 | 13.3% |
| 70 000 | 13.6% |
| 80 000 | 13.7% |

1. A moldable thermosetting composition comprising:
a polyester resin or vinyl ester epoxy resin (A) in solution in a liquid monomer comprising ethylenic unsaturation (B);
at least one antishrink additive (C);
an organic peroxide catalyst; and
an inorganic filler;
characterised in that:
the liquid monomer comprising ethylenic unsaturation (B) is vinyltoluene and/or t-butylstyrene; and
the antishrink additive(s) (C) is/are devoid of acid functionality and is/are chosen from copolymers of methol methacrylate and of a comonomer which is a vinyl monomer and/or methyl acrylate and/or ethyl acrylate, in solution in the monomer comprising ethylenic unsaturation (B).

2. The composition as claimed in claim 1, characterized in that the monomer comprising ethylenic unsaturation (B) is vinyltoluene.

3. The composition as claimed in claim 1, characterized in that the polyester resin or vinyl ester epoxy resin (A) is in solution in vinyltoluene in a proportion of 10 to 70% and preferably of 20 to 65% by weight.

4. The composition as claimed in claims 1, characterized in that the copolymer (C) is a copolymer of methyl methacrylate and of styrene.

5. The composition as claimed in claim 4, characterized in that the copolymer (C) is a copolymer of methyl methacrylate and of styrene comprising from 20 to 60% and preferably from 40 to 50% by weight of styrene.

6. The composition as claimed in claim 4 or claim 5, characterized in that the copolymer of methyl methacrylate and of styrene exhibits a eight-average molar mass of between 50 000 and 500 000 g/mol.

7. The composition as claimed in claims 1, characterized in that it additionally comprises a setting agent.

8. The composition as claimed in claims 1, characterized in that the resin (A) is an unsaturated polyester deriving from maleic acid, from its anhydride or from fumaric acid and from at least one diol.

9. The composition as claimed in claims 1, characterized in that the inorganic filler is calcium carbonate.

10. The composition as claimed in claim 1, characterized in that it comprises:
(A) from 8 to 30% of unsaturated polyester of the maleic type, added in the form of solution in vinyltoluene (B),
(C) from 4 to 15% of a copolymer of methol methacrylate and of styrene, added in the form of a solution in vinyltoluene (B),
(D) from 30 to 70% of calcium carbonate,
(E) from 0.2 to 1% of an organic peroxide,
(f) from 5 to 50% of reinforcing fibers, and
(G) from 0.6 to 1.2% of wetting agent.

11. The composition as claimed in claims 1, characterized in that it is homogeneous.

12. A process for the preparation of a thermosetting composition as claimed in of claims 1, comprising:
if appropriate, a stage of producing a first blend of the inorganic filler with optimal additives,
a stage of producing a second blend of the constituents (A), (B) and (C) and of the other optional liquid or soluble constituents, and
a stage of introducing the inorganic filler or if appropriate, the first blend into the second blend.

13. The process as claim in claim 12, characterized in that the copolymer (C) is employed in the form of beads which are dissolved in the monomer (B).

14. The process as claim in claim 13, characterized in that the beads have a size of between 30 and 400 microns and preferably between 60 and 200 microns.

15. A rigid item, obtained by crosslinking a composition as claimed in claim 1 or obtained by the process as claimed in claim 12.

16. The use of an item as claimed in claim 15 in the fields of the automotive industry, of electricity, of domestic electrical applies or of construction.

17. A solution of a copolymer of methyl methacrylate and of styrene as defined in of claim 4 in vinyltoluene.

18. A thermosetting composition comprising a solution as claimed in claim 17.

19. The use of a solution as claimed in claim 17 in a thermosetting composition.
